(19) United States
(12) Patent Application Publication
(10) Pub. No.: US 2007/0092827 A1
(43) Pub. Date: Apr. 26, 2007

(54) Inks for use on light-activated imaging media

(76) Inventors: Makarand P. Gore, Corvallis, OR (US); Vladek Kasperchik, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/254,272

(22) Filed: Oct. 20, 2005

(51) Int. Cl. G03C 1/00

(52) U.S. Cl. 430/270.1

(57) ABSTRACT

An light activated imaging medium comprises a substrate and an imaging composition disposed on the substrate, the composition comprising a matrix and a color-forming agent within the matrix and an alloy of at least two leuco dyes, the leuco dyes having at least first and second melting points, respectively, and the alloy having a melting point between at least two of the melting points.

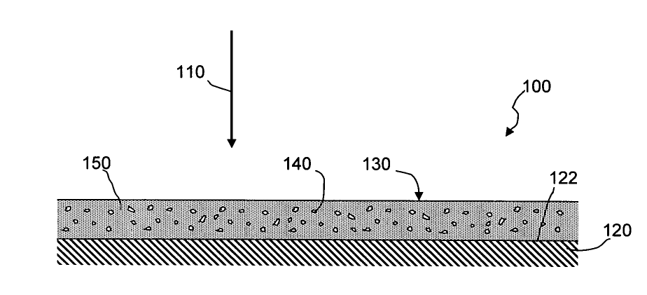

### BACKGROUND

Digital data are recorded on CDs, DVDs, and other optical media by using a laser to create pits in the surface of the medium. The data can then be read by a laser moving across them and detecting variations in the reflectivity of the surface. While this method is effective for creating machine-readable features on the optical medium, those features are not easily legible to the human eye.

Materials that produce color change upon stimulation with energy such as light or heat may be used to create human-readable images. For ease of discussion, and without subscribing to any particular effect, such materials will be referred to herein as “thermochromic materials” (which change color by the action of heat) and that term as used herein is intended to encompass photochromic materials (which change color by the action of light). Leuco dyes are one kind of thermochromic material and are particularly well-suited to use with optical media because they can be activated with the same laser that is used to burn digital data onto the optical media, with the result that a single system can be used to produce both machine- and human-readable data on a CD, DVD, or other optical device.

One type of thermochromic coating that can be used with a laser is an ink comprising a leuco dye, a proton source (developer), and an ink vehicle (matrix). In many cases, the ink vehicle may be a mixture of radiation curable monomers and oligomers (UV-curable lacquer). The developer can be a proton source such as highly acidic phenol or any other suitable proton source.

Leuco dyes in their crystalline form have relatively low solubilities in the lacquer. By contrast, the amorphous forms of many leuco dyes have significantly higher solubilities. The developer often has good solubility in the lacquer. Thus, during ink preparation: a) developer is dissolved in the lacquer and forms a relatively stable solution; and b) leuco dye in the amorphous form is dissolved in the lacquer and allowed to crystallize into its less soluble crystalline form. The resulting ink typically consists of 2 distinctive phases: 1) crystallized leuco dye; 2) lacquer phase with developer dissolved in it. Alternatively, pre-crystallized leuco dye may be added to the lacquer.

Inks formulated this way may be printed/coated as a thin coating (1-20 um) and cured into polymer matrix by electromagnetic radiation (typically UV). A color change in the ink coating can be brought about by raising its temperature. Upon heating, at least one phase and preferably both phases of the coating melt, the leuco dye phase dissolves in the matrix phase, while developer molecules can migrate and dissolve in the leuco dye phase. Thus dye molecules begin to come into contact with developer. Intimate contact of leuco dye and developer at high temperature results in proton transfer from developer to leuco dye and causes a color change of the latter. Rapid cooling of the system preserves the color change by preventing re-crystallization of the dye. Because the melted area is relatively small, the coating is relatively thin, and the coating is in contact with the significantly thicker substrate, sufficiently rapid cooling is not difficult to achieve.

Because the dye becomes visible only when it has been melted and dissolved in the matrix, the melting point of the leuco dye becomes an important factor in manufacturing and processing. If the heat source is a laser having a fixed power output, the amount of time required to heat the ink to its melting point will depend directly on how high that melting point is. Reducing the time required for marking requires either supplying a more powerful laser, or providing a dye that melts at a lower temperature. At the same time, the lower the melting point of the dye, the more susceptible the ink will be to extraneous marking and overall degradation. As each leuco dye has a single melting point, it is difficult to achieve the dual objectives of rapid marking and resistance to extraneous marking.

Hence it is desirable to provide an ink containing a leuco dye that avoids the shortcomings of prior dyes.

### BRIEF SUMMARY

A light activated imaging medium comprises a substrate and an imaging composition disposed on said substrate. The imaging composition comprises: a matrix, and within the matrix a developer and a color-forming agent comprising an alloy of at least two leuco dyes, the leuco dyes having first and second melting points and the alloy having a melting point between said melting points.

### BRIEF DESCRIPTION OF THE DRAWINGS

For a detailed description of exemplary embodiments of the invention, reference will now be made to the accompanying drawing, which shows an imaging medium according to an embodiment of the present invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ”

As mentioned above, the term “thermochromic” includes photochromic (light activated) materials and is used herein to describe a chemical, material, or device that changes from one color to another, or from a colorless state to a colored state, as discerned by the human eye, when it undergoes a change in temperature.

The term “leuco dye” is used to refer to a color forming substance that is colorless or one color in a non-activated state and produces or changes color in an activated state. As used herein, the terms “developer” and “activator” describe a substance that reacts with the leuco dye and causes the dye to alter its chemical structure and change or acquire color.

The term “light” refers to any type of electromagnetic radiation, including but not limited to UV, IR, near UV, blue and red radiation.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Referring briefly to the drawing, there is shown an imaging medium 100 and energy beam 110. Imaging medium 100 may comprise a substrate 120 having a surface 122 and imaging composition 130 disposed on surface 122. Imaging composition 130 in turn includes a matrix 150 and suspended color forming particles 140. Substrate 120 may be any substrate upon which it is desirable to make a mark, such as, by way of example only, paper (e.g., labels, tickets, receipts, or stationary), overhead transparencies, or the labeling surface of a medium such as a CD-R/RW/ROM or DVD±R/RW/ROM. Imaging composition 130 may be applied to the substrate via any acceptable method, such as, by way of example only, rolling, spin-coating, spraying, or screen printing.

As described in detail below, imaging composition 130 may comprise a matrix material, an optional fixing agent, an optional radiation-absorbing compound such as a dye (sometimes referred to as an “antenna”), and a color-forming agent. The color-forming agent may be any substance that undergoes a human-detectable optical change in response to a threshold stimulus, which may be applied in the form of light, heat, or pressure. In some embodiments, the color-forming agent may comprise at least one leuco dye and a developer. The developer and the leuco dye produce a visible color change when mixed. Either of the developer and the leuco dye may be soluble in the matrix. The other component (developer or leuco dye) may be substantially insoluble in the matrix and is suspended in the matrix as distributed particles 140. The optional fixing agent and optional antenna may each be dissolved in the matrix phase or may be present as finely ground powder dispersed in the matrix phase.

When it is desired to make a mark, energy 110 is directed imagewise onto imaging medium 100. The form of energy may vary depending upon the equipment available, ambient conditions, and desired result. Examples of energy that may be used include but are not limited to IR radiation, UV radiation, x-rays, or visible light. Energy 110 typically takes the form of a laser beam of a predetermined frequency. Various components of imaging medium 100 absorb energy 110, which causes localized heating of imaging medium 100. In particular, the antenna, if present, absorbs the energy and facilitates the localized heating. In order to produce a visible mark, the localized heating must be sufficient to raise suspended particles 140 to a temperature sufficient to allow the color forming species that is initially present in the particles to diffuse into the adjacent matrix material. In order for diffusion to happen quickly, that matrix temperature should be well above its melting temperature. Melting of both color-former and matrix phases is preferred for fast and efficient color formation. For example, the target temperatures may be significantly above the glass transition temperature (Tg) and/or melting temperature (Tm) of both color-former particles 140 and the matrix material.

If the power of available energy source, e.g., a laser, is pre-selected or predetermined, the rate of heating will depend on the ability of the imaging medium to absorb energy and on the time period of the exposure. Various means for enhancing the ability of the imaging medium to absorb energy are known and are beyond the scope the present disclosure. By way of example only, antenna dye is an additive that increase the ability of the imaging medium to absorb energy. Nonetheless, the overall efficiency of the imaging system would be improved if the leuco dye itself could efficiently absorb the available radiation.

It has been discovered that the fusion of two or more leuco dyes produces a dye alloy that exhibits properties intermediate to those of the original ingredients. In particular, it has been discovered that it is possible to “tune” the dye alloy so it has a desired melting point. Thus, a first leuco dye having a melting point Tₘ₁ and a second leuco dye having a different melting point Tₘ₂ can be alloyed to produce a dye alloy having a pre-selected melting point T_{mA} that is between Tₘ₁ and Tₘ₂. In order to produce a leuco dye alloy, melting and mixing of the component dyes is enough in most cases. An antenna dye and/or a melting aid may be included as optional components of the leuco dye alloy. If three or more dyes are used to form the dye, the relative amounts of each can be controlled to produce an alloy having the desired melting point.

In some embodiments, the ink may contain two or more leuco dyes that are selected such that at least one leuco dye is partially soluble in the matrix before thermal activation. It has been discovered that if the alloying dyes have different solubilities in the matrix material, it is possible to form an imaging composition that has an inherent desired background color. Specifically, if one of the component dyes has a solubility that is lower than the solubility of the other dye, the more-soluble dye will be present in the cured matrix at a higher concentration and can therefore produce a visible background color in the imaging composition 130 at ambient temperatures, i.e., in the unmarked imaging composition. In this case, the partially soluble leuco dye provides background coloration to the coating prior to marking.

The solubilities of the component dyes are very dependent on their molecular structures and can be controlled by various known means, including but not limited to controlling the number, structure and length of side chains on the dye molecules, including structural features such as a variety of aromatic rings, such as indole, pyrrole, and fused pyran rings, and/or changing nature of the monomers/oligomers comprising the matrix phase. By providing an inherent background color, the need for additional layers or coloring dyes with other functionalities is eliminated.

The ability to prepare dye alloys with desired melting points allows preparation of imageable coatings that balance stability and reactivity, i.e., optimize the competing considerations of marking speed and archive life. In addition, the inks produced from lower melting or slightly soluble dyes have lower viscosities and are easier to print and manufacture.

Dyes

Dyes that may be alloyed in accordance with the present invention include, but are not limited to: leuco dyes such as fluoran leuco dyes and phthalide color formers as described in “The Chemistry and Applications of Leuco Dyes,” Muthyala, Ramiah, ed., Plenum Press (1997) (ISBN 0-30645459-9). Embodiments may include almost any known leuco dye, including, but not limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)4,5-diphenylimidazoles, indanones, leuco indamines, hydrozines, leuco indigold dyes, amino-2,3-dihydroanthraquinones, tetrahalo-p,p′-biphenols, 2(p-hydroxyphenyl)4,5-diphenylimidazoles, phenethylanilines, and mixtures thereof. In other embodiments, the leuco dye may comprise a fluoran, phthalide, aminotriarylmethane, or mixtures thereof.

Particularly suitable leuco dyes include:
2′-Anilino-3′-methyl-6′-(dibutylamino)-fluoran: 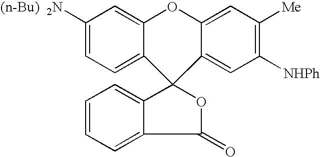
2-Anilino-3-methyl-6-(N-ethyl-N-isoamylamino)fluoran: 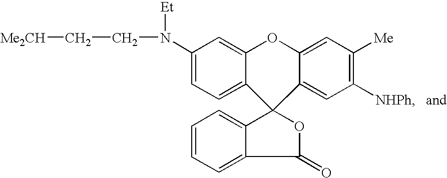
2-Anilino-3-methyl-6-(di-n-amylamino)fluoran: 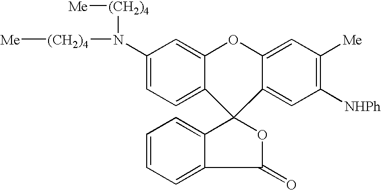
All three dyes are commercially available from Nagase Co of Japan.

Additional examples of dyes include Pink DCF CAS#29199-09-5; Orange-DCF, CAS#21934-68-9; Red-DCF CAS#26628-47-7; Vermilion-DCF, CAS#117342-26-4; Bis(dimethyl)aminobenzoyl Phenothiazine, CAS# 1249-97-4; Green-DCF, CAS#34372-72-0; Chloroanilino Dibutylaminofluoran, CAS#82137-81-3; NC-Yello-3 CAS#36886-76-7; Copikem37, CAS#144190-25-0; and Copikem3, CAS#22091-92-5.

Several non-limiting examples of suitable fluoran based leuco dyes may include 3-diethylamino-6-methyl-7-anilinofluorane, 3-(N-ethyl-p-toluidino)-6-methyl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-N-methylamino)-6-methyl-7-anilinofluorane, 3-diethylamino-7-(m-trifluoromethylanilino)fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(o-chloroanilino)fluorane 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofluranone,4,5,6,7-tetrachloro-3,3-bis[2-[4-(dimethylamino)phenyl]-2-(4-methoxyphenyl)ethenyl], and mixtures thereof. Aminotriarylmethane leuco dyes may also be used in the present invention such as tris(N,N-dimethylaminophenyl)methane (LCV); deutero-tris(N,N-dimethylaminophenyl)methane (D-LCV); tris(N,N-diethylaminophenyl)methane (LECV); deutero-tris(4-diethylaminolphenyl)methane (D-LECV); tris(N,N-di-n-propylaminophenyl)methane (LPCV); tris(N,N-din-butylaminophenyl)methane (LBCV); bis(4-diethylaminophenyl)-(4-diethylamino-2-methyl-phenyl)methane (LV-1); bis(4-diethylamino-2-methylphenyl)-(4-diethylamino-phenyl)methane (LV-2); tris(4-diethylamino-2-methylphenyl)methane (LV-3); deutero-bis(4-diethylaminophenyl)-(4-diethylamino-2-methylphenyl)methane (D-LV-1); deutero-bis(4-diethylamino-2-methylphenyl)(4-diethylaminophenyl)methane (D-LV-2); bis(4-diethylamino-2-methylphenyl)(3,4-diemethoxyphenyl)methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl.

Generally, the melting point of the mixture of dyes will be lower than that of the higher melting dye (melting point depression), based on the mole fraction of lower melting dye. The dye mixtures preferably contain two dye whose melting points are at least 20° C. and preferably approximately 50° C. apart.

Developers may include, without limitation, proton donors, for example acidic phenolic compounds such as bisphenol-A, bisphenol-S, p-hydroxy benzyl benzoate, TG-SA (phenol, 4,4′-sulfonylbis[2-(2-propenyl)]), poly-phenols and sulfonylureas such as Pergafast-201.

The leuco dye may also be present as a separate phase in the form of a low-melting eutectic. The eutectic may comprise an alloy of fluoran dye and a melting aid. Melting aids, also referred to as “accelerators,” may include crystalline organic solids with melting temperatures in the range of about 50° C. to about 150° C., and alternatively melting temperature in the range of about 70° C. to about 120° C. Suitable accelerators may include aromatic hydrocarbons (or their derivatives) that provide good solvent characteristics for leuco dye. The melting aid may assist in reducing the melting temperature of the leuco dye and stabilize the leuco dye alloy in the amorphous state (or slow the recrystallization of the leuco dye alloy into individual components). Suitable melting aids for use in the current invention may include, but are not limited to, m-terphenyl, p-benzyl biphenyl, y-naphtol benzylether, and 1,2[bis(3,4]dimethylphenyl)ethane. Other species that may stabilize amorphous phase in leuco dye melts include polymeric species such as acrylate or methacrylate polymers or co-polymers. More generally, any polymeric species soluble in hot leuco dye melt has the potential to act as an amorphous phase stabilizer.

One or both of the developer and at least one of the dye components may be soluble in the matrix at ambient conditions, while the other is substantially insoluble in the matrix at ambient conditions. By “substantially insoluble,” it is meant that the solubility of that component of the color-forming agent in the lacquer at ambient conditions is so low, that no or very little color change may occur due to reaction of the dye and the developer at ambient conditions. Although the developer may be dissolved in the matrix with at least one dye component being present as small crystals suspended in the matrix at ambient conditions, as in the embodiments described above, in other embodiments the dye(s) may be dissolved in the matrix and the developer may be present as small crystals suspended in the matrix at ambient conditions.

Regardless of the nature of the color-forming agent, an absorber or antenna that is tuned to a desired frequency may be included in the ink so as to increase absorbance of the available light energy. In some embodiments, the absorber or antenna is tuned to the frequency of the laser that will be used to create the desired marks. By effectively absorbing the available light, the absorber or antenna increase the heating effect of the laser, thereby enhancing the thermochromic response.

Without limitation, the antenna may be selected from the following compounds. For use with a 780 nm laser, preferred dyes include but are not limited to:
(A) silicon 2,3 naphthalocyanine bis(trihexylsilyloxide) (Formula 1) (Aldrich 38,993-5, available from Aldrich, P.O. Box 2060, Milwaukee, Wis. 53201), and matrix soluble derivatives of 2,3 naphthalocyanine (Formula 2) 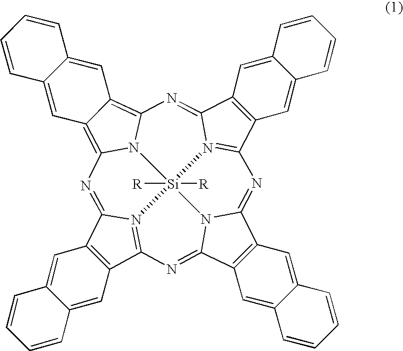
   where R=—O—Si—(CH₂(CH₂)₄CH₃)₃; 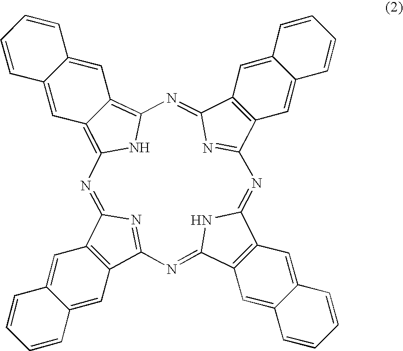
(B) matrix soluble derivatives of silicon phthalocyanine, described in Rodgers, A. J. et al., 107 J. PHYS. CHEM. A 3503-3514 (May 8, 2003), and matrix soluble derivatives of benzophthalocyanines, described in Aoudia, Mohamed, 119 J. AM. CHEM. SOC. 6029-6039 (Jul. 2, 1997), (substructures illustrated by Formula 3 and Formula 4, respectively): 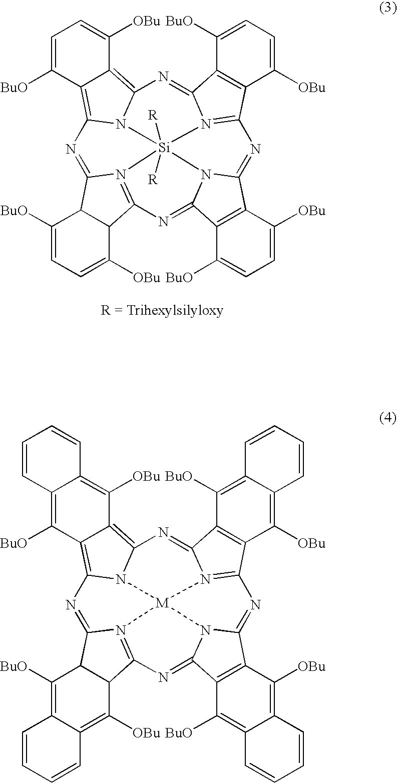
   where M is a metal, and;
(C) compounds such as those shown in Formula 5 (as disclosed in U.S. Pat. No. 6,015,896) 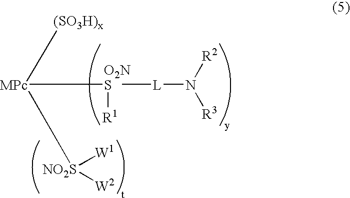
   where M is a metal or hydrogen; Pc is a phthalocyanine nucleus; R¹, R², W¹, and W² are independently H or optionally substituted alkyl, aryl, or aralkyl; R³ is an aminoalkyl group; L is a divalent organic linking group; x, y, and t are each independently 0.5 to 2.5; and (x+y+t) is from 3 to 4;
(D) compounds such as those shown in Formula 6 (as disclosed in U.S. Pat. No. 6,025,486) 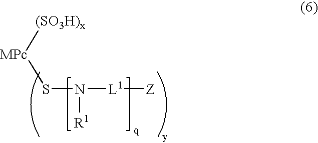
   where M is a metal or hydrogen; Pc is a phthalocyanine nucleus; each R¹ independently is H or an optionally substituted alkyl, aryl, or aralkyl; L¹ independently is a divalent organic linking group; Z is an optionally substituted piperazinyl group; q is 1 or 2; x and y each independently have a value of 0.5 to 3.5; and (x+y) is from 2 to 5; or
(E) 800NP (a proprietary dye available from Avecia, PO Box 42, Hexagon House, Blackley, Manchester M9 8ZS, England), a commercially available copper phthalocyanine derivative.

Additional examples of the suitable radiation antenna can be selected from a number of radiation absorbers such as, but not limited to, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable antennas can also be used in the present system and method and are known to those skilled in the art and can be found in such references as Infrared Absorbing Dyes, Matsuoka, Masaru, ed., Plenum Press, New York, 1990 (ISBN 0-306-43478-4) and Near-infrared Dyes for High Technology Applications, Daehne, Resch-Genger, Wolfbeis, Kluwer Academic Publishers (ISBN 0-7923-5101-0), both of which are incorporated herein by reference.

Consideration can also be given to choosing the radiation antenna such that any light absorbed in the visible range does not adversely affect the graphic display or appearance of the color forming composition either before or after development. For example, in order to achieve a visible contrast between developed areas and non-imaged or non-developed areas of the coating, the color former can be chosen to form a color that is different than that of the background. For example, color formers having a developed color such as black, blue, red, magenta, and the like can provide a good contrast to a more yellow background. Optionally, an additional non-color former colorant can be added to the color forming compositions of the present system and method or the substrate on which the color forming composition is placed. Any known non-color former colorant can be used to achieve almost any desired background color for a given commercial product. Although the specific color formers and antennae discussed herein are typically separate compounds, such activity can also be provided by constituent groups of binders and/or color formers which are incorporated in the activation and/or radiation absorbing action of color former. These types of color former/radiation absorbers are also considered to be within the scope of the present system and method.

Various radiation antennas can act as an antenna to absorb electromagnetic radiation of specific wavelengths and ranges. Generally, a radiation antenna that has a maximum light absorption at or in the vicinity of the desired development wavelength can be suitable for use in the present system and method. For example, in certain embodiments of the present system and method, the color forming composition can be optimized within a range for development using infrared radiation having a wavelength from about 720 nm to about 900 nm.

The matrix material may be any composition suitable for dissolving and/or dispersing the developer, and color former (or color former/melting aid alloy). Acceptable matrix materials may include, by way of example only, UV curable matrices such as acrylate derivatives, oligomers and monomers, with a photo package. A photo package may include a light absorbing species which initiates reactions for curing of a matrix, such as, by way of example, benzophenone derivatives. Other examples of photoinitiators for free radical polymerization monomers and pre-polymers include but are not limited to: thioxanethone derivatives, anthraquinone derivatives, acetophenones and benzoine ether types. It may be desirable to choose a matrix that can be cured by a form of radiation other than the type of radiation that causes a color change.

Matrices based on cationic polymerization resins may require photo-initiators based on aromatic diazonium salts, aromatic halonium salts, aromatic sulfonium salts and metallocene compounds. An example of an acceptable matrix or matrix may include Nor-Cote CLCDG-1250A or Nor-Cote CDG000 (mixtures of UV curable acrylate monomers and oligomers), which contains a photoinitiator (hydroxy ketone) and organic solvent acrylates (e.g., methyl methacrylate, hexyl methacrylate, beta-phenoxy ethyl acrylate, and hexamethylene acrylate). Other acceptable matrixs or matrices may include acrylated polyester oligomers such as CN292, CN293, CN294, SR351 (trimethylolpropane tri acrylate), SR395 (isodecyl acrylate), and SR256 (2(2-ethoxyethoxy)ethyl acrylate) available from Sartomer Co.

The imaging compositions formed in the manner described herein can be applied to the surface of a light activated imaging medium such as a CD, DVD, or the like. When the color-forming agent, optional antenna, and other components are selected appropriately, the same laser that is used to “write” the machine-readable data onto the light activated imaging medium can also be used to “write” human-readable images, including text and non-text images, onto the medium.

In certain embodiments, the machine-readable layers are applied to one surface of the light activated imaging medium and the present imaging compositions are applied to the opposite surface of the light activated imaging medium. In these embodiments, the user can remove the disc or medium from the write drive after the first writing process, turn it over, and re-insert it in the write drive for the second writing process, or the write drive can be provided with two write heads, which address opposite sides of the medium. Alternatively, separate portions of one side of the light activated imaging medium can be designated for each of the machine- and human-readable images.

Thus, embodiments of the present invention are applicable in systems comprising a processor, a laser coupled to the processor, and a data storage medium including a substrate having a first surface that can be marked with machine-readable marks by said laser and a second surface that can be marked with human-readable marks by said laser. The second surface includes an imaging composition in accordance with the invention, comprising a color-forming agent that includes an alloy of at least two leuco dyes having a predetermined melting point.

By way of example only, three dye blends were created using the dye amounts set out below. The exemplary alloys contained various combinations of Noveon Specialty Cyan 39™, Noveon Specialty Magenta 3™ (both available from Noveon, Cincinnati, Ohio), Cirrus 715™ available from Avecia, England, and m-Terphenyl available from Aldrich chemical company Milwaukee, Wis. The glass transition temperatures of resulting alloyed dyes were between those of the component ingredients and were controllable by varying the relative amounts of the component dyes.

### EXAMPLE 1

| Component | Weight | Color | T_{g} |
|---|---|---|---|
| Specialty Magenta 3 | 88.2 g | Light Magenta | Viscous |
| M-Terphenyl | 9.8 g | | Liquid <25° C. |
| Cirrus 715 | 2 g | | |

### EXAMPLE 2

| Component | Weight | Color | T_{g} |
|---|---|---|---|
| Specialty Magenta 3 | 45 g | Light Magenta | 49° C. |
| Noveon 39 | 45 g | | |
| Cirrus 715 | 10 g | | |

### EXAMPLE 3

| Component | Weight | Color | T_{g} |
|---|---|---|---|
| Specialty Magenta 3 | 9.8 g | Light Cyan | 76° C. |
| Noveon 39 | 88.2 g | | |
| Cirrus 715 | 2 g | | |

The above discussion is meant to be illustrative of the principles and various embodiments of the present invention. Numerous variations and modifications will become apparent to those skilled in the art once the above disclosure is fully appreciated. For example, the compositions and relative amounts of the matrix, color-forming agent, developer, if any, and antenna, if any, can all be varied. It is intended that the following claims be interpreted to embrace all such variations and modifications. Similarly, unless explicitly so stated, the sequential recitation of steps in any claim is not intended to require that the steps be performed sequentially or that any step be completed before commencement of another step.

What is claimed is:

1. A light activated imaging medium, comprising:
a substrate; and
an imaging composition disposed on said substrate, said composition comprising:
a matrix; and
a color-forming agent within said matrix and comprising an alloy of at least two leuco dyes, said at least two leuco dyes having at least first and second melting points, respectively, and said alloy having a melting point between at least two of said melting points.

2. The light activated imaging medium of claim 1 wherein said color-forming agent further comprises a developer, wherein said developer is soluble in said matrix and said alloy is present as particles within said matrix.

3. The light activated imaging medium of claim 1 wherein the composition of said alloy is selected such that said color-forming agent has a pre-selected melting point.

4. The light activated imaging medium of claim 1 wherein one of said dyes is sufficiently soluble in said matrix to provide a visible color to said matrix at ambient temperatures.

5. The light activated imaging medium of claim 1 wherein said imaging composition further includes an antenna.

6. The light activated imaging medium of claim 1 wherein said at least two leuco dyes are selected from the group consisting of fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)4,5-diphenylimidazoles, and phenethylanilines.

7. The light activated imaging medium of claim 1 wherein the alloy comprises at least two dyes selected from the group consisting of Noveon Specialty Cyan 39™, Noveon Specialty Magenta 3™ Cirrus 715™, and m-Terphenyl.

8. The light activated imaging medium of claim 1 wherein the imaging composition further includes a melting aid.

9. A method for providing human-readable and machine-readable marks on a light activated recording medium, comprising:
providing at least one imageable composition on said recording medium, said imageable composition including a color-forming agent comprising an alloy of at least two leuco dyes in a matrix, said at least two leuco dyes having at least first and second melting points, respectively, and said alloy having a melting point between at least two of said melting points;
providing energy to said imageable composition so as to cause localized heating of said imageable composition.

10. The method of claim 9 wherein said color-forming agent further comprises a developer, wherein said developer is soluble in said matrix and said alloy is present as particles within said matrix.

11. The method of claim 9 wherein the composition of said alloy is selected such that said color-forming agent has a pre-selected melting point.

12. The method of claim 9 wherein one of said dyes is sufficiently soluble in said matrix to provide a visible color to said matrix at ambient temperatures.

13. The method of claim 9 wherein said imaging composition further includes an antenna.

14. The method of claim 9 wherein said at least two leuco dyes are selected from the group consisting of fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)4,5-diphenylimidazoles, and phenethylanilines.

15. A system, comprising:
a processor,
a laser coupled to said processor;
a data storage medium including a substrate having a first surface that can be marked with machine-readable marks by said laser and a second surface that can be marked with human-readable marks by said laser, said second surface including an imaging composition comprising:
a matrix; and
a color-forming agent within said matrix and comprising an alloy of at least two leuco dyes, said at least two leuco dyes having at least first and second melting points, respectively, and said alloy having a melting point between at least two of said melting points.

16. The system of claim 15 wherein said color-forming agent further comprises a developer, wherein said developer is soluble in said matrix and said alloy is present as particles within said matrix.

17. The system of claim 15 wherein the composition of said alloy is selected such that said color-forming agent has a pre-selected melting point.

18. The system of claim 15 wherein one of said dyes is sufficiently soluble in said matrix to provide a visible color to said matrix at ambient temperatures.

19. The system of claim 15 wherein said imaging composition further includes an antenna.

20. The system of claim 15 wherein said at least two leuco dyes are selected from the group consisting of fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(p-hydroxyphenyl)4,5-diphenylimidazoles, indanones, leuco indamines, hydrozines, leuco indigoid dyes, amino-2,3-dihydroanthraquinones, tetrahalo-p,p′-biphenols, 2(p-hydroxyphenyl)4,5-diphenylimidazoles, and phenethylanilines.

21. The system of claim 15 wherein the alloy comprises at least two dyes selected from the group consisting of Noveon Specialty Cyan 39™, Noveon Specialty Magenta 3™ Cirrus 715™, and m-Terphenyl.

22. A means for providing human-readable on a light activated imaging medium, comprising:
first means for recording human-readable marks on said medium, said first means including color-forming means for producing a human-detectable optical change in response to an optical signal, said color-forming means comprising an alloy of at least two leuco dyes, said at least two leuco dyes having at least first and second melting points, respectively, and said alloy having a melting point between at least two of said melting points.
